(19) United States
(12) Patent Application Publication
(10) Pub. No.: US 2025/0263012 A1
(43) Pub. Date: Aug. 21, 2025

(54) VEHICLE APPROACH NOTIFICATION DEVICE

(71) Applicant: Toyota Jidosha Kabushiki Kaisha, Toyota-shi (JP)

(72) Inventors: Masaki KATAGIRI, Toyota-shi (JP); Teppei Kawasaki, Toyota-shi (JP)

(73) Assignee: TOYOTA JIDOSHA KABUSHIKI KAISHA, Toyota-shi (JP)

(21) Appl. No.: 18/954,898

(22) Filed: Nov. 21, 2024

(30) Foreign Application Priority Data
Feb. 16, 2024 (JP) 2024-022223

(51) Int. Cl. B60Q 5/00

(52) U.S. Cl. CPC B60Q 5/008

(57) ABSTRACT

The vehicle approach notification device includes a sound pressure control unit that controls the sound pressure of an approach notification sound outputted from a sound generator provided in electrified vehicle toward the outside of the vehicle in accordance with the vehicle speed of electrified vehicle. The sound pressure control unit is configured to control such that, when the vehicle speed of electrified vehicle is larger than the threshold-value vehicle speed, the sound pressure of the approach notification sound gradually decreases as the vehicle speed of electrified vehicle increases.

### CROSS-REFERENCE TO RELATED APPLICATION

This application claims priority to Japanese Patent Application No. 2024-022223 filed on Feb. 16, 2024, incorporated herein by reference in its entirety.

### BACKGROUND

### 1. Technical Field

The present specification discloses an improvement of a vehicle approach notification device.

### 2. Description of Related Art

An electrified vehicle such as a battery electric vehicle or a hybrid electric vehicle travels using a driving force of a motor during low-speed travel. Thus, unlike the engine-driven vehicle, the electrified vehicle does not emit much noise during low-speed travel. Therefore, it may be difficult for a person (e.g., a pedestrian) around the electrified vehicle to notice that the electrified vehicle is nearby. Thus, conventionally, the electrified vehicle outputs an approach notification sound toward the outside of the vehicle during low-speed travel, in order to allow a person around the electrified vehicle to notice that the electrified vehicle is nearby. It is stipulated in the laws and regulations of each country that the electrified vehicle must output an approach notification sound toward the outside of the vehicle during low-speed travel.

Conventionally, there has been proposed a technique of controlling the output of an approach notification sound. For example, Japanese Unexamined Patent Application Publication No. 2012-121518 (JP 2012-121518 A) discloses a vehicle approach notification device including a speaker that outputs an approach notification sound toward the outside of the vehicle. The vehicle approach notification device changes the pitch (frequency, i.e., tone) of the approach notification sound to be output from the speaker according to the vehicle speed of the electrified vehicle. Further, the vehicle approach notification device changes the output level of the approach notification sound output from the speaker according to the pitch of the approach notification sound.

### SUMMARY

As the vehicle speed of the electrified vehicle increases, noise (background noise) emitted from the electrified vehicle increases. Thus, in the laws and regulations of each country, it is stipulated that the electrified vehicle should output an approach notification sound during low-speed travel. In other words, the law does not stipulate that the electrified vehicle must output an approach notification sound during high-speed travel. Thus, when the vehicle speed of the electrified vehicle increases, there is no need to output an approach notification sound according to the law. Therefore, the electrified vehicle stops the approach notification sound when the vehicle speed becomes equal to or higher than a predetermined vehicle speed.

Here, when the approach notification sound is stopped, a person around the electrified vehicle or an occupant may feel uncomfortable (be surprised or the like). This will be described in detail with reference to FIG. 4.

FIG. 4 is a graph illustrating the relationship between the vehicle speed and the sound pressure of the approach notification sound in the conventional electrified vehicle. In the graph of FIG. 4, the horizontal axis represents the vehicle speed of the electrified vehicle, and the vertical axis represents the sound pressure of the approach notification sound output from the electrified vehicle or the background noise. When the vehicle speed is less than 0, it is meant that the electrified vehicle is traveling in reverse. In the example of FIG. 4, the unit of the sound pressure is [dBA], that is, the sound pressure is represented by the A-weighted sound pressure level. Here, the sound pressure is a sound pressure at predetermined positions from the electrified vehicle, as prescribed by the laws and regulations. For example, the law stipulates that the sound pressure should be a sound pressure at two positions at a height of 1.2 meters, 2 meters to the left and 2 meters to the right from the position of the front end of the electrified vehicle and the center in the vehicle width direction. Therefore, the sound pressure in FIG. 4 also indicates the sound pressure at such positions.

A point Pa, a point Pb, and a point Pc indicated in FIG. 4 represent the vehicle speed and the sound pressure of the approach notification sound stipulated by the law. For example, in the law represented by the point Pa, it is stipulated that an approach notification sound having a sound pressure of La or higher should be output when the vehicle speed of the electrified vehicle is Va (when the electrified vehicle is traveling in reverse at the vehicle speed Va since Va is less than 0). In the law represented by the point Pb, it is stipulated that an approach notification sound having a sound pressure of Lb or higher should be output when the vehicle speed of the electrified vehicle is Vb. In the law represented by the point Pc, it is stipulated that an approach notification sound having a sound pressure of Lc or higher should be output when the vehicle speed of the electrified vehicle is Vc. The vehicle speed Vc is higher than the vehicle speed Vb, and the sound pressure Lc is higher than the sound pressure Lb. That is, the law requires that an approach notification sound having a higher sound pressure should be output as the vehicle speed of the electrified vehicle increases.

The solid line in FIG. 4 indicates the relationship between the vehicle speed of the electrified vehicle and the sound pressure of the approach notification sound output from the electrified vehicle. For example, in the electrified vehicle, an approach notification sound having a sound pressure corresponding to the vehicle speed is output so as to meet the law represented by the point Pa, the point Pb, and the point Pc. Specifically, when the vehicle speed of the electrified vehicle is the vehicle speed Va, an approach notification sound having the sound pressure La or higher is output. When the vehicle speed of the electrified vehicle is the vehicle speed Vb, an approach notification sound having the sound pressure Lb or higher is output. When the vehicle speed of the electrified vehicle is the vehicle speed Vc, an approach notification sound having the sound pressure Lc or higher is output. According to the law, when the vehicle speed of the electrified vehicle is higher than 0, the sound pressure of the approach notification sound increases as the vehicle speed of the electrified vehicle increases.

In the present specification, the highest vehicle speed among a plurality of vehicle speeds prescribed by the law is referred to as a statutory maximum vehicle speed. In the example of FIG. 2, the statutory maximum vehicle speed is the vehicle speed Vc (in this case, indicated as the statutory maximum vehicle speed Vc). The law does not require that an approach notification sound should be output when the vehicle speed of the electrified vehicle is higher than the statutory maximum vehicle speed Vc. Thus, the electrified vehicle may stop outputting the approach notification sound when the vehicle speed of the electrified vehicle is higher than the statutory maximum vehicle speed Vc. In the example of FIG. 4, the electrified vehicle stops outputting the approach notification sound (sets the sound pressure of the approach notification sound to 0 [dBA]) at a speed Vp1 (Vp1>statutory maximum vehicle speed Vc), which has a slight margin from the statutory maximum vehicle speed Vc.

When the output of the approach notification sound is stopped at the vehicle speed Vp1, the approach notification sound that has been output at the sound pressure of Lc or higher is suddenly stopped. Consequently, a person around the electrified vehicle may feel uncomfortable.

The broken line in FIG. 4 indicates the relationship between the vehicle speed of the electrified vehicle and the sound pressure of the background noise. Here, the background noise is a sound emitted from the electrified vehicle other than the approach notification sound, and includes a motor sound of the electrified vehicle, road noise, etc., for example. As indicated in FIG. 4, the sound pressure of the background noise increases as the vehicle speed increases. Even if the approach notification sound is suddenly stopped, it is less likely that a person around the electrified vehicle feels uncomfortable because of the presence of the background noise. That is, the background noise acts to reduce a sense of discomfort felt by a person around the electrified vehicle when the approach notification sound is stopped. However, if a difference ALI between the sound pressure of the approach notification sound at the vehicle speed Vp1 (immediately before stop) and the sound pressure of the background noise at the vehicle speed Vp1 is large, a person around the electrified vehicle still feels uncomfortable.

The present disclosure provides a vehicle approach notification device capable of reducing a sense of discomfort felt by a person around an electrified vehicle by stopping an approach notification sound output from the electrified vehicle.

An aspect of the present disclosure provides a vehicle approach notification device including

a sound pressure control unit that controls a sound pressure of an approach notification sound output from a sound generator provided in an electrified vehicle toward outside of the vehicle according to a vehicle speed of electrified vehicle, in which
the sound pressure control unit is configured to perform control such that the sound pressure of the approach notification sound gradually decreases as the vehicle speed of electrified vehicle increases when the vehicle speed of the electrified vehicle is higher than a threshold vehicle speed.

The sound pressure control unit may be configured to stop output of the approach notification sound from the sound generator when a difference between the sound pressure of the approach notification sound and a sound pressure of background noise becomes equal to or less than a threshold sound pressure as a result of the sound pressure of the approach notification sound gradually decreasing as the vehicle speed of the electrified vehicle increases.

According to the vehicle approach notification device of the present disclosure, it is possible to reduce a sense of discomfort felt by a person around an electrified vehicle by stopping an approach notification sound output from the electrified vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration schematic diagram of a vehicle approach notification device according to the present embodiment;

FIG. 2 is a diagram showing the contents of a sound pressure control function showing the relationship between the vehicle speed and the sound pressure of the approach notification sound in the present embodiment;

FIG. 3 is a flow chart showing a flow of a process of creating a sound pressure control function; and

FIG. 4 is a graph showing the relation between the vehicle speed and the sound pressure of the approach notification sound in the conventional electrified vehicle.

### DETAILED DESCRIPTION OF EMBODIMENTS

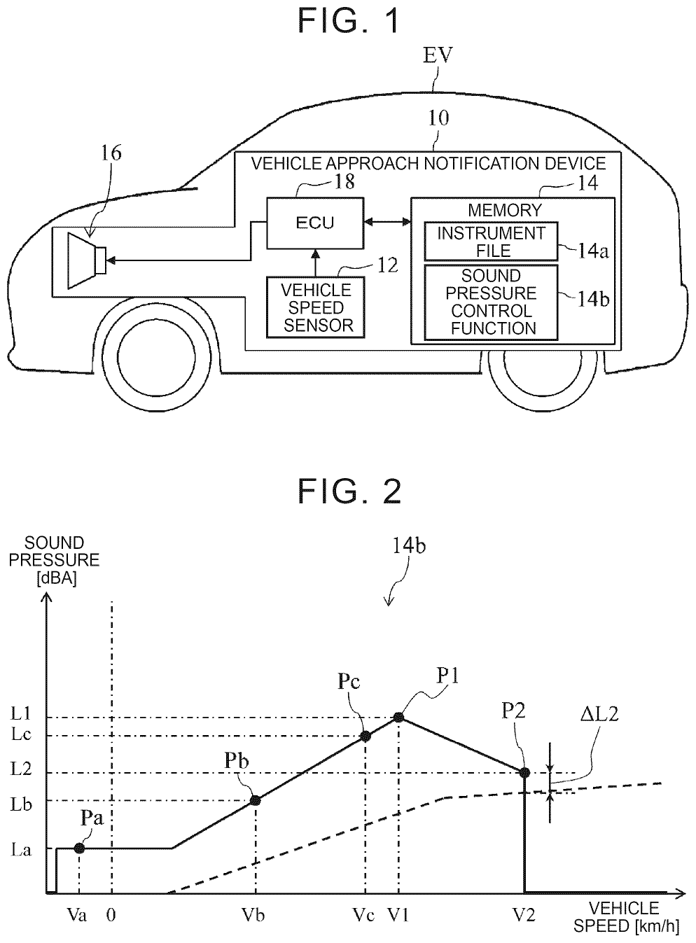

FIG. 1 is a configuration schematic diagram of a vehicle approach notification device 10 according to the present embodiment. The vehicle approach notification device 10 is provided at least in an electrified vehicle EV where the vehicle travels with the driving force of the motor during low-speed traveling. Electrified vehicle EV is a battery electric vehicle, a hybrid electric vehicle, or the like. The vehicle approach notification device 10 includes a vehicle speed sensor 12, a memory 14, a speaker 16, and an ECU 18. ECU 18 is communicably connected to the vehicle speed sensor 12, the memories 14, and the speakers 16.

The vehicle speed sensor 12 is a sensor that detects the vehicle speed of electrified vehicle EV. For example, the vehicle speed sensor 12 detects the vehicle speed by detecting the rotational speed of the output shaft of the transmission. The vehicle speed sensor 12 may be any sensor as long as electrified vehicle EV vehicle speed can be detected. The vehicle speed detected by the vehicle speed sensor 12 is inputted to ECU 18.

The memories 14 are configured to include Solid State Drive (SSD), embedded Multi Media Card (eMMC), Read Only Memory (ROM), or Random Access Memory (RAM). The memory 14 stores a vehicle approach notification program for operating each unit of the vehicle approach notification device 10. The approach notification program may be stored in a non-transitory computer-readable storage medium such as a USB memory or a SD card. The vehicle approach notification device 10 can read and execute the vehicle approach notification program from such a storage medium.

The sound source file 14a and the sound pressure control function 14b are stored in the memory 14. The sound source file 14a is a sound data representing an approach notification sound. The sound pressure control function 14b is a function indicating a relation between the vehicle speed of electrified vehicle EV and the sound pressure of the approach notification sound outputted from electrified vehicle EV. The sound pressure control function 14b will be described later.

The speaker 16 serving as a sound generator outputs an approach notification sound toward the outside of the vehicle at a sound pressure in accordance with control from ECU 18, based on control from ECU 18. In the present embodiment, the speaker 16 outputs the sound obtained by reproducing the sound source file 14a to the outside of the vehicle as an approach notification sound. The sound generator is not limited to the speaker 16 as long as the sound pressure of the approaching notification sound to be outputted can be changed by control from ECU 18, and may be, for example, a piezoelectric sounder, a buzzer, or the like.

ECU 18 includes, for example, a processor and peripheral components thereof. ECU 18 controls the sound pressure of the approach notification sound outputted from the speaker 16 in accordance with the vehicle-approach notification program stored in the memory 14. Specifically, ECU 18 controls the sound pressure of the approach notification sound outputted from the speaker 16 by controlling the amplitude of the voltage of the audio signal which is an electric signal supplied to the speaker 16. In particular, ECU 18 controls the sound pressure of the approach notification sound outputted from the speaker 16 according to the vehicle speed of electrified vehicle EV detected by the vehicle speed sensor 12. That is, ECU 18 functions as a sound pressure control unit.

FIG. 2 is a diagram showing the content of the sound pressure control function 14b showing the relation between the vehicle speed and the sound pressure of the approach notification sound in the present embodiment. In the present embodiment, ECU 18 controls the sound pressure of the approach notification sound outputted from the speaker 16 in accordance with the sound pressure control function 14b. The sound pressure control function 14b is created in advance by a designer of the vehicle approach notification device 10 and stored in the memories 14. In the present embodiment, the sound pressure control function 14b is a graph as shown in FIG. 2. However, the sound pressure control function 14b may be any type of function as long as it indicates the relation between the vehicle speed of electrified vehicle EV and the sound pressure of the approach notification sound.

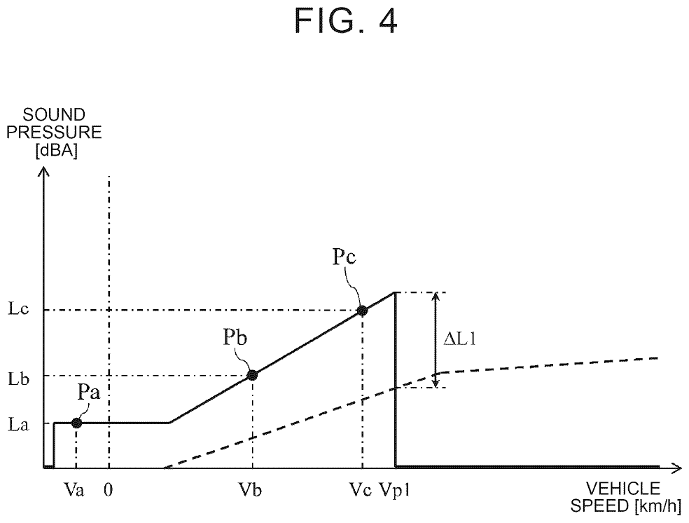

In FIG. 2, similarly to FIG. 4, the horizontal axis represents the vehicle speed of electrified vehicle EV, and the vertical axis represents the sound pressure of the approaching notification sound or the background noise outputted from electrified vehicle EV. The sound pressure in FIG. 2 also indicates the sound pressure at a predetermined position with respect to electrified vehicle EV, which is stipulated by laws and regulations. That is, the predetermined position is, for example, two positions in the height 1.2 meters from the position of the vehicle front end and the vehicle width-direction center of electrified vehicle EV to the left by 2 meters and the right by 2 meters.

As in the related art, ECU 18 controls the sound pressure of the approach notification sound in accordance with the vehicle speed so as to satisfy the legal regulations represented by a plurality of point Pa,Pb,Pc. At least, ECU 18 controls such that the sound pressure of the approaching notification sound increases as the vehicle speed increases so as to satisfy the law in a speed range equal to or lower than the maximum vehicle speed Vc of the law.

ECU 18 controls the sound pressure of an approach notification sound that differs from a conventional one in a velocity range larger than the legal maximal vehicle speed Vc. Conventionally, as shown in FIG. 4, the approach notification sound is stopped at a vehicle speed Vp1 which is a vehicle speed larger than the legal maximum vehicle speed Vc. On the other hand, in the present embodiment, ECU 18 performs control such that the sound pressure of the approach notification sound gradually decreases as the vehicle speed of electrified vehicle EV increases when the vehicle speed of electrified vehicle EV is larger than the vehicle speed V1 as the threshold vehicle speed that is the vehicle speed equal to or higher than the legal maximum vehicle speed Vc. This is determined between the vehicle speed V1 and the vehicle speed V2 in FIG. 2.

Further, ECU 18 performs the following control because the sound pressure of the approach notification sound gradually decreases as the vehicle speed of electrified vehicle EV increases from the vehicle speed V1. That is, ECU 18 stops outputting the approach notification sound from the speaker 16 when the difference between the sound pressure of the approach notification sound and the sound pressure of the background noise (ΔL2 in FIG. 2) becomes equal to or lower than the threshold sound pressure (when the vehicle speed of electrified vehicle EV becomes the vehicle speed V2 in FIG. 2). Thereafter, in the velocity range larger than the vehicle speed V2, ECU 18 does not output an approach notification sound from the speaker 16.

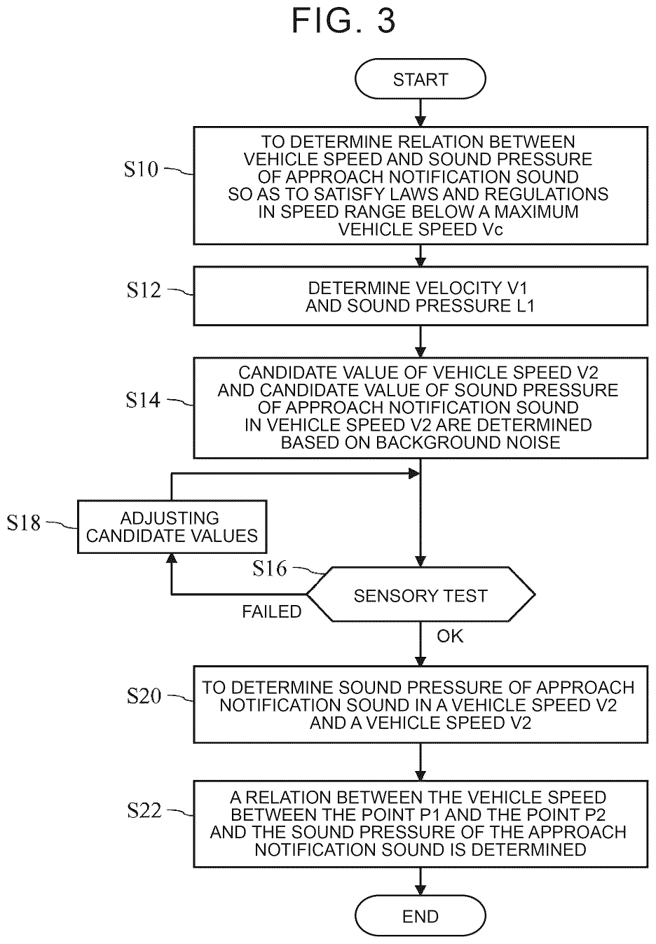

Hereinafter, referring to FIG. 2, the sound pressure control function 14b will be described in detail along with the flow of the process of creating the sound pressure control function 14b in accordance with the flow chart of FIG. 3. The details of the sound pressure control function 14b are details of the control of the sound pressure of the approach notification sound according to the vehicle speed of electrified vehicle EV by ECU 18.

In S10, in the velocity range equal to or lower than the legal maximum vehicle speed Vc, the relation between the vehicle speed of electrified vehicle EV and the sound pressure of the approach notification sound is determined so as to satisfy the legal regulations in the same manner as in the related art. Specifically, as the vehicle speed of electrified vehicle EV increases, the sound pressure of the approach notification sound also increases.

In S12, a vehicle speed V1 larger than the statutory largest vehicle speed Vc is determined. As shown in FIG. 2, in the sound pressure control function 14b, the vehicle speed V1 is the vehicle speed (V1>the regulated maximum vehicle speed Vc) that takes a margin with respect to the regulated maximum vehicle speed Vc, but the vehicle speed V1 may be larger than the regulated maximum vehicle speed Vc. Then, the sound pressure L1 of the approach notification sound in the vehicle speed V1 is determined. The sound pressure L1 is set to a sound pressure (L1≥Lc) equal to or higher than the sound pressure Lc at the maximum vehicle speed Vc. A point represented by the vehicle speed V1 and the sound pressure L1 in the sound pressure control function 14b is referred to as a point P1.

In S14, a candidate value of the vehicle speed V2 which is a vehicle speed larger than the vehicle speed V1 and is a vehicle speed at which the approach notification sound is stopped, and a candidate value of the sound pressure L2 of the approach notification sound at the vehicle speed V2 are determined. The vehicle speed V2 candidates may be larger than the vehicle speed V1. However, when the difference between the vehicle speed V2 and the vehicle speed V1 is small, as the vehicle speed of electrified vehicle EV changes from the vehicle speed V1 to the vehicle speed V2, the sound pressure of the approach notification sound rapidly decreases from the sound pressure L1, and the output of the approach notification sound is stopped at the vehicle speed V2. Therefore, the effect of the present disclosure is reduced. Therefore, the candidate value of the vehicle speed V2 is determined such that the difference between the vehicle speed V2 and the vehicle speed V1 is equal to or greater than the predetermined value. In the present embodiment, the vehicle speed V2 candidates are determined such that differences between the vehicle speed V1 and the vehicle speed V2 are approximately 15 [km/h] to 20 [km/h], for example.

Next, candidates for sound pressure L2 are determined. The sound pressure L2 candidates are sound pressures that are smaller than the sound pressure L1. In particular, the candidate value of the sound pressure L2 is determined such that the difference ΔL2 between the candidate value of the sound pressure L2 and the sound pressure of the background noise in the vehicle speed V2 is equal to or lower than the threshold sound pressure. The threshold sound pressure may be, for example, 5 [dBA].

Here, as described above, the background noise is a sound other than the approach notification sound emitted by electrified vehicle EV, and includes, for example, a motor sound of electrified vehicle EV, a road noise, and the like. Also in FIG. 2, the relation between the vehicle speed of electrified vehicle EV and the sound pressure of the background noise is indicated by a broken line. The sound pressure of background noise increases as the vehicle speed increases. Therefore, the larger the vehicle speed V2, the larger the candidate value of the sound pressure L2, and conversely, the smaller the vehicle speed V2, the smaller the candidate value of the sound pressure L2.

Sensory testing is performed in S16. The sensory test is a test for stopping the approach notification sound based on the candidate value of the vehicle speed V2 and the candidate value of the sound pressure L2 determined by S14 and determining whether or not the human (examiner) actually feels uncomfortable around electrified vehicle EV. When the examiner feels uncomfortable (FAILED in S16) as a result of the sensory test, S18 is returned, and the sound pressure L2 candidates are adjusted. Specifically, in order to make the difference ΔL2 smaller, the sound pressure L2 candidates are adjusted to be smaller. In addition, in S18, the candidate value of the vehicle speed V2 may be adjusted in addition to the candidate value of the sound pressure L2 so as to further reduce the difference ΔL2. If the sensory test reveals that the examiner does not feel uncomfortable (OK in S16), S20 proceeds.

In S20, the candidate value of the vehicle speed V2 and the candidate value of the sound pressure L2 determined by S14 or the candidate value of the vehicle speed V2 and the candidate value of the sound pressure L2 adjusted by S18 are determined as the vehicle speed V2 and the sound pressure L2. A point represented by the vehicle speed V2 and the sound pressure L2 in the sound pressure control function 14b is referred to as a point P2.

In S22, the relation between the vehicle speed and the sound pressure of the approach notification sound between the point PI and the point P2 is determined. Specifically, the relation between the vehicle speed and the sound pressure of the approach notification sound is determined so that the sound pressure of the approach notification sound gradually decreases as the vehicle speed increases from the vehicle speed V1 to the vehicle speed V2. In the embodiment of FIG. 2, as the vehicle speed increases from the vehicle speed V1 to the vehicle speed V2, the sound pressure of the approach notification sound decreases linearly, but this is not necessarily the case.

As shown in FIG. 4, in the related art, the approach notification sound is stopped when the vehicle speed of electrified vehicle EV becomes the vehicle speed Vp1.

On the other hand, in the present embodiment, even if the vehicle speed of electrified vehicle EV becomes the vehicle speed V1, the approach notification sound is not stopped, and as the vehicle speed increases from the vehicle speed V1, the sound pressure of the approach notification sound gradually decreases. As a result, at least the difference between the sound pressure of the approach notification sound immediately before the approach notification sound is stopped and the sound pressure of the background noise is reduced. Therefore, when the approach notification sound is stopped, a person in the vicinity of electrified vehicle EV or an uncomfortable feeling felt by the occupant is reduced.

In particular, in the present embodiment, control is performed so that the difference ΔL2 between the sound pressure L2 of the approach notification sound immediately before the approach notification sound is stopped (in the vehicle speed V2) and the sound pressure of the background noise in the vehicle speed V2 is equal to or lower than the threshold sound pressure. Therefore, the uncomfortable feeling felt by the person or the occupant around electrified vehicle EV is more reliably reduced.

Although the embodiment of the vehicle approach notification device according to the present disclosure has been described above, the vehicle approach notification device according to the present disclosure is not limited to the above-described embodiment, and various modifications can be made without departing from the gist thereof.

What is claimed is:

1. A vehicle approach notification device comprising a sound pressure control unit that controls a sound pressure of an approach notification sound output from a sound generator provided in an electrified vehicle toward outside of the vehicle according to a vehicle speed of electrified vehicle, wherein the sound pressure control unit is configured to perform control such that the sound pressure of the approach notification sound gradually decreases as the vehicle speed of electrified vehicle increases when the vehicle speed of the electrified vehicle is higher than a threshold vehicle speed.

2. The vehicle approach notification device according to claim 1, wherein the sound pressure control unit is configured to stop output of the approach notification sound from the sound generator when a difference between the sound pressure of the approach notification sound and a sound pressure of background noise becomes equal to or less than a threshold sound pressure as a result of the sound pressure of the approach notification sound gradually decreasing as the vehicle speed of the electrified vehicle increases.
